(19) United States
(12) Patent Application Publication
(10) Pub. No.: US 2018/0126771 A1
(43) Pub. Date: May 10, 2018

(54) FRACKED COLOR-SHIFTING SECURITY DEVICE

(71) Applicant: Crane & Co., Inc., Boston, MA (US)

(72) Inventors: Pearl N. Dickerson, New Boston, NH (US); Nancy J. Gettens, Waban, MA (US); Gerald Nkwantah, Pepperell, MA (US); David L. Peters, Amherst, NH (US)

(73) Assignee: Crane & Co., Inc., Boston, MA (US)

(21) Appl. No.: 15/801,908

(22) Filed: Nov. 2, 2017

Related U.S. Application Data
(60) Provisional application No. 62/418,531, filed on Nov. 7, 2016.

(51) Int. Cl. B42D 25/45; B42D 25/373; B42D 25/328; B42D 25/425; B42D 25/369; B42D 25/445; G02B 5/00; G02B 5/08; G02B 5/18

(52) U.S. Cl. CPC B42D 25/45; B42D 25/373; B42D 25/328; B42D 25/425; B42D 25/29; B42D 25/445; G02B 5/003; G02B 5/0808; G02B 5/1814; B42D 25/369

(57) ABSTRACT

The present invention provides a security device having layers or material stacked over each other to provide a color-shifting effect, an indicia effect, optional detection effect, fracking effect and a forensic feature.

### RELATED APPLICATION

This application claims priority to U.S. Provisional Patent Application Ser. No. 62/418,531, filed Nov. 7, 2016, which is incorporated herein in its entirety by reference.

### TECHNICAL FIELD

Layered systems are often used to produce security devices where the devices provide optically varying effects that are very difficult to replicate. In industries that involve the sale and/or manufacture of high value or high security products, such as currency documents, identification documents, expensive personal apparel, national security products, and the like, it is critical that consumers and users of such products have confidence that the products they are using are authentic. With the recent advent of certain high resolution printers and other replication technologies such as 3-D printing, it has become even more critical that such high value or high security products are readily and easily susceptible to authentication by consumers. Applicant has developed certain devices that are aimed at thwarting the efforts of those who would seek to counterfeit those high value or high security products. These devices are formed from a layered system that produces color-shifting effects and indicia effects that are readily observable yet are very difficult to replicate even in view the current technological advancements highlighted above. The devices also provide a fracking effect that functions as a forensic feature and an optional detection effect that allows the covert incorporation of a security feature that can be detected with a machine.

### BACKGROUND

As noted above, due in part to the technological advances made in the printer industry and other replication and duplication technologies, proprietors of high value products or high security products have consistently demanded security devices and features that can be used to distinguish their authentic products from products of counterfeiters. Often times, it is also required that these security devices provide aesthetic features.

For example, the efficiency and improved quality of modern photocopiers have coincided with increases in counterfeited security documents such as identification cards, banknotes, checks, stamps and the like. Several attempts have already been made to prevent such documents from being counterfeited. These include, for example, providing security devices that produce mobile optical effects. These effects are observable as the images present in the security device appear to move when the security device is viewed from varying angles or points of view. In other security devices these mobile effects are presented as color-shifting effects where images in a security device appear to change color(s) as the security device is viewed from varying angles or points of view. Such color-shifting effects are likewise difficult to replicate and thereby serve as suitable mechanisms for authenticating high value or high security products or documents. Other devices provide mobile effects in the form of reflection/transmission effects where the image and/or the color observed through reflected light is different from that observed through transmitted light. In other instances various combinations of these mobile effects are presented in security devices to improve authentication.

U.S. Pat. No. 7,085,058 (hereinafter the '058 patent) describes a security element that has a flip-flop color shifting effect, a micro-text effect and also has magnetic properties that provide a detection effect. Quite simply put, the effectiveness of such a security device as a counterfeit deterrent is tied to the number of security effects that can be incorporated therein and to the complexity of replication of such effects. For example, while the '058 patent discloses a security device that can contain three security effects, a security device that can include four or more security effects would improve the device's effectiveness as a counterfeit deterrent. Similarly, a device that could improve the quality of security effects already present in the device would also improve the effectiveness of the security device.

While the security device of the '058 patent provides a micro-text effect, this effect is susceptible to a sunglassing detriment whereby the micro-text is not easily discernible in reflected light. The security device of the '058 patent includes a first bi-layer (magnetic layer and reflector) layered on a second bi-layer (dielectric and absorber), which may also in turn be layered on a substrate layer. Gaps—in the form of indicia—are present in the magnetic layer and the reflector layer thereby providing a micro-text effect. The absorber, dielectric and reflector operate to provide a color-shifting effect while a separate layer (the magnetic layer) of magnetic material operates to provide a magnetic code that can be read. As such, the device of the '058 patent provides three security effects. The micro-text effect suffers from relatively low resolution in reflected light because the second bi-layer (dielectric and/or absorber layers) diminishes the contrast between the gaps and the surrounding areas, thereby producing the aforementioned sunglassing detriment. This sunglassing detriment is due in part to the opacity of the second bi-layer of dielectric and absorber, which can be seen beneath the gaps. This opacity of the second bi-layer is responsible for the relative reduction in contrast between the gaps and the surrounding areas. The impact on the micro-text effect is thereby impacted through the reduced resolution of the indicia, particularly in reflected light. Accordingly, the sunglassing detriment translates into a reduced effectiveness of the micro-text effect provided by the device in the '058 patent.

Heretofore processes of removing or mitigating the sunglassing detriment and thereby increasing the effectiveness of the micro-text effect were unavailable. However, through experimentation, Applicant has developed a process for producing a color-shifting security device whereby this security device is equipped with a micro-text effect that demonstrates improved resolution, relative to the conventional devices. This security device also provides at least one additional or different security effect thereby increasing the complexity of the security device.

### SUMMARY

Applicant, through careful experimentation and thorough development have discovered that a security device can readily and easily provide verification that a product is authentic by providing a layered security device having a color-shifting effect, an indicia effect, a frack effect, and an optional detection effect. It is also contemplated within the bounds of this invention that the security device may be used to provide or impart aesthetic effects and that the device may be combined with other security effects,

The present invention, in certain aspects, provides a security device, a method of producing the security device and a secured product containing the security device.

The security device, in one embodiment comprises (a) a color-shifting effect element, which includes an absorber, a dielectric and a reflector that are layered such that the dielectric is disposed between the absorber and the reflector; (b) an indicia effect element having (i) gaps in the reflector and (ii) a frack effect element disposed beneath the gaps in the reflector.

The security device, in another embodiment, comprises (a) a color-shifting effect element that includes an absorber, a dielectric and a reflector that are layered such that the dielectric is disposed between the absorber and the reflector; (b) an optional detection effect element; and (c) an indicia effect element having (i) at least one gap in each or at least one of the reflector and the optional detection effect element, when present, and (ii) a frack effect element in at least one of the dielectric and the absorber. The color-shifting effect element is layered with the optional detection effect element, when present, such that the reflector is disposed between the dielectric and the detection effect element,

The method of producing the security device, in one embodiment, comprises (a) providing a color-shifting effect element, optionally layered with a detection effect element, which includes an absorber, a dielectric and a reflector that are themselves layered such that the dielectric is disposed between the absorber and the reflector; (b) creating gaps in the reflector and optionally the detection effect element; and (c) reducing the opacity of the dielectric and/or absorber, relative to the opacity of the dielectric and/or absorber in areas adjoining the gaps and a frack effect element. In one embodiment, the step of reducing the opacity of the dielectric and absorber bi-layer provides a regolith layer, which is defined and described in more detail below.

The method of producing the security device, in one embodiment, comprises (a) providing a color-shifting effect element, optionally layered with a detection effect element, which includes an absorber, a dielectric and a reflector that are themselves layered such that the dielectric is disposed between the absorber and the reflector; (b) providing a patterned masking element that is layered with the color-shifting effect element to provide masked areas and exposed areas; (c) creating gaps in the reflector and optionally in the detection effect element by removing portions of the masked areas or exposed areas; and (d) reducing the opacity of the dielectric and absorber by (racking at least one of the dielectric and the absorber in the areas beneath the gaps to produce a frack effect element disposed beneath the gap.

A person having ordinary skill in the art (PHOSITA) would understand that numerous methods may be employed for creating gaps in the reflector and optionally in the detection effect element. However, in preferred embodiments of the present invention, the gaps are created by at least one of washing, mechanical drilling, etching, or spark erosion; preferably by either washing or etching and more preferably by etching.

While numerous methods are contemplated within the scope of the present invention for reducing the opacity of the dielectric, or the combined opacity of the dielectric and the absorber bi-layer, it is herein preferred that the opacity is reduced by fracking the at least one of the dielectric and the absorber.

The present invention encompasses the use of various patterned masking elements for providing masked areas and exposed areas. Nonetheless, in preferred embodiments, a suitable patterned masking element includes a patterned resist element, for example, a layer of resist having a pattern of areas where resist material is present and areas where resist material is absent. The patterned resist element is layered on or over the color-shifting effect element, and in particular layered on the reflector. However, where a detection effect element is layered over the reflector the patterned resist element may be layered between the reflector and the detection effect element or may be layered over both the reflector and detection effect element or layered beneath both the reflector and the detection effect element. In the present invention, the patterned resist element is layered, as described, with the other elements of the security device to form masked areas and exposed areas.

In preparing the security device, the patterned masking element may either be removed or left in place after the etching of the exposed areas. Accordingly, in one embodiment, the security device comprises a patterned resist element layered over the reflector. It is therefore also contemplated within the scope of the invention that in one embodiment a detection effect element is layered on or over the patterned resist element.

Where the method of creating gaps in the reflector and/or the detection effect element is by washing, the patterned resist is a washable resist. By washing away the resist in the masked areas, at least portions of the reflector and/or the detection effect element are also washed away to create the gaps in the reflector and/or the detection effect element. Alternatively, or in addition, where the method of creating gaps in the reflector and/or the detection element is by etching, at least portions of the reflector and/or the detection effect element are removed by etching away portions of the reflector and/or detection effect element in the exposed areas.

In certain embodiments presented herein, a detection effect element is provided as an optional element of the security device. In a preferred embodiment, the detection effect element is present and is layered with or within the color-shifting effect element. For example, the detection effect element may be layered on or above the color-shifting effect element; layered on by the reflector; or layered below the reflector.

Creating gaps in the detection effect element may be by either the same or a separate process as that used to produce gaps in the reflector. The gaps can be formed in the reflector and the detection effect element, simultaneously or sequentially. For example, the gaps can be formed by creating gaps in the reflector then layering the detection effect element over the color-shifting effect element without obscuring any gaps already formed in the reflector (e.g., by masking the gap areas) or by layering the detection effect element with or within the color-shifting effect element and creating gaps in the reflector and the detection effect element by the same process by either etching away both the detection effect element and the reflector in exposed areas or by washing away resist in masked areas to remove both the reflector and detection effect element in the masked areas. Of course, even where the process is the same it is often a matter of course that the reflector or the detection effect element may be removed only substantially simultaneous (i.e., one before the other using the same method of creating the gaps).

The product, in one aspect is a secured product and in one embodiment comprises (a) a substrate and (b) at least one security device, as described herein, affixed to the substrate such that it is at least partially detectable. Various products are contemplated within the scope of the present invention and the security device may provide either aesthetics or authenticity to the product, or both.

The subject invention will be described in further details below by reference to several aspects and embodiments of the claimed invention. While such embodiments and their details are provided such that a PHOSITA may be able to understand and practice the claimed invention, such embodiments are not intended to limit the scope of the claimed invention. Embodiments provided herein are therefore provided as non-limiting examples of the claimed invention. Further features of the claimed invention, including those not explicitly described herein, will therefore become apparent, to a PHOSITA, from the following description of exemplary embodiments and are likewise contemplated within the scope of the subject invention.

### WRITTEN DESCRIPTION

### Definitions

A used herein, the term “disposed between” refers to the instances where an object, material or element is situated between multiple of other objects, materials or elements and may or may not be in direct contact with the other objects, materials or elements.

As used herein, the term “etch” refers to the act of removing by washing away by hydraulic force or chemically dissolving away portions of a material, or to the act of mechanically removing portions of a material, or any combination thereof, to provide the gaps.

As used herein, the term “exposed areas” refers to the areas in the security device, or a precursor to the security device, beneath the patterned resist in areas having missing resist where at least one of a detection effect element, a reflector, a dielectric or an absorber are present.

As used herein, the term “gap” or “gaps” refers to the indentations created in the “exposed areas” of the device that are in the form of indicia such as letters, symbols, numbers, images and the like.

As used herein, the term “layered” refers to the relative disposition of the elements of the security device whereby a first element or material is stacked above or beneath a second element or material; either in direct contact or disposed at a distance such as where a third element or material is disposed between the first and second.

As used herein, the term “layered with” is intended to cover embodiments where materials are layered over or below and either adjoining or separated.

As used herein, the term “masked areas” refers to areas in the security device, or a precursor to the security device, that are set beneath the patterned resist in areas where the resist is present.

As used herein, the term “patterned” as used in the term patterned resist refers to a display having multiple contrasting areas such as the display in a layer of resist where a contrast is provided by having areas of resist near areas of missing resist

### BRIEF DESCRIPTION OF DRAWINGS

FIG. 1 is a cross-section of a color-shifting effect element.

FIG. 2 is a cross-section of a color-shifting effect element with a detection effect element layered with the color-shifting effect element.

FIG. 3 is a cross-section of a color-shifting effect element with a device substrate layered with the color-shifting effect element.

FIGS. 3a-3d are cross-sections of intermediate products formed from steps of the method of manufacturing a security device where the color-shifting effect element layered over a device substrate and with patterned resist (FIG. 3a) is etched leaving gaps in the reflector (R) (FIG. 3b), then the bilayer of dielectric (D) and absorber (A) is fracked leaving behind a regolith layer of bilayer residue (FIG. 3c), and then the color-shifting effect element is layered with a detection effect element (m) (FIG. 3d).

FIG. 4 is a cross-section of a color-shifting effect element with a detection effect element layered above the color-shifting effect element and a device substrate layered below the color-shifting effect element.

FIGS. 4a-4c are cross-sections of intermediate products formed from steps of the method of manufacturing a security device where the color-shifting effect element layered over a device substrate and layered under a detection effect element (m) and with patterned resist (FIG. 4a), is washed to remove the resist material and to leave gaps in the detection effect element (m) and reflector (R) (FIG, 4b), and then the bilayer of dielectric (D) and absorber (A) is fracked leaving behind a regolith layer of bilayer residue (FIG. 4c).

FIGS. 5a-5c are cross-sections of intermediate products formed from steps of the method of manufacturing a security device where the color-shifting effect element with patterned resist includes a diffraction element and is layered over a device substrate (FIG. 5a), is washed to remove the resist material and to leave gaps in the reflector (R) (FIG. 5b), and then the bilayer of dielectric (D) and absorber (A) is fracked leaving behind a regolith layer of bilayer residue (FIG. 5c).

FIGS. 6a-6b are top plan views of a security device demonstrating overt color-shifting effect and indicia effect from one point of view (FIG. 6a) and from another point of view (FIG. 6b).

### DETAILED DESCRIPTION

As noted above, the present invention, in certain aspects, provides a security device, a method of producing the security device and a product comprising the security device; a secured product.

An embodiment of the security device comprises (a) a color-shifting effect element, which includes an absorber, a dielectric and a reflector that are layered such that the dielectric is disposed between the absorber and the reflector; and (b) an indicia effect element having (i) gaps in the reflector and (ii) a frack effect element disposed beneath the gaps in the reflector.

As used herein, the term “color-shifting effect element” refers to an element or component of the security device that is responsible for providing the security device with a color-shifting effect. A “color-shifting effect,” as used herein refers to the change in color that is observable when the points of view from which the security device is viewed are varied. Various color changes are contemplated including, for example, gold-to-green, magenta-to-gold, magenta-to-silver, green-to-magenta, green-to-silver, blue-to-green, red-to-green, and blue-to-red. The color-shifting effect element is a layered system of a dielectric disposed between an absorber and a reflector. It is also contemplated herein that several absorber and dielectric layers may be layered, especially in alternating fashion, to produce the color-shifting effect element. Moreover, in certain embodiments it is contemplated that instead of alternating the absorber and dielectric layers, that multiple dielectric layers are provided that are adjoining where at least two of these adjoining dielectric layers have differing indices of refraction. In any case, it is Applicant's preference that the dielectric layer is alternated with an absorber layer since such an ordering tends to produce a more pronounced color-shifting effect or will at least increase the visibility of the color-shifting effect.

The color-shifting effect is dependent on the kind of material used and number of layers of such materials. Materials suitable for producing the color-shifting effect and for producing the color-shifting effect element will be apparent to the PHOSITA. For example, several suitable materials are provided in U.S. Pat. No. 3,858,977, EP 0 395 410, EP 0 341 002 and WO 2001/03945, which are herein incorporated by reference for such teachings. The color-shifting effect may also be observable by varying the point of view from reflective to transmissive or vice versa, which also depends on factors such as number of layers, but also on the layer thicknesses and the indices of refraction.

The security device also includes an indicia effect element which produces an indicia effect. The indicia effect element allows indicia present in the security device to be easily observed in both reflected and transmitted light. The indicia effect element comprises a gap and a frack effect element where the frack effect element is disposed beneath the gap in the above-lying layer(s). Visibility of indicia in the security device depends on the degree of contrast between the gaps and the surrounding materials in the security device. In the present invention, the frack effect element improves the contrast observable in reflected and transmitted light by reducing the opacity (increasing the transparency) of the layered areas beneath the gaps, such as the dielectric and/or the absorber. Together, the gap and the frack effect element function to provide a contrast against the surrounding layers of the color-shifting effect element or any other components layered against the color-shifting effect element. However, without the frack effect element, and indeed without the frack effect, a sunglassing detriment would be present which would narrow the contrast between the gaps and the surrounding materials in the security device. The frack effect element removes or mitigates the sunglassing detriment, thereby functioning in combination with the gaps to provide an indicia of higher (relative to conventional security devices with sunglassing detriment) resolution. A relative improvement in indicia resolution (e.g., reduced feathering or gradient edges) is obtained for both reflected and transmitted light.

A gap is formed by removing portions of a layer(s) forming the security device. In view of the present disclosure, a PHOSITA will understand that various methods of removing at least portions of any layer are available and are contemplated herein. Suitable methods include at least one of washing, mechanical drilling, etching, or spark erosion.

As used herein the term “washing” refers to the process of applying, such as by layering, a washable resist onto or beneath a component into which gaps are to be formed; preferably beneath. The resist is in the form of a patterned resist layer as described herein, such that masked areas and exposed areas are provided in the component into which gaps are to be formed. For example, where the gaps are to be formed in the reflector, the patterned resist element is applied over or beneath the reflector. Gaps are then formed in the reflector by subjecting the patterned resist layer to a chemical reaction that removes resist from the masked areas thereby also removing portions of the reflector in the masked areas. It is contemplated that other layers above the dielectric may also be similarly washed to produce gaps. For example, where a detection effect element is present, the patterned resist layer may be disposed above or below the detection effect element or between the detection effect element and the reflector. Washing away of the resist in the masked areas will also remove at least portions of the reflector and the detection effect element to create gaps in the reflector and the detection effect element. Washing is a preferred method of forming gaps in layers of the security device.

Another preferred method of forming gaps in layers of the security device is etching. As used herein, the term “etch” or “etching” refers to the process of applying a patterned masking element, such as a patterned resist element, over a component or layer into which gaps are to be formed. The patterned masking element is layered over the component into which gaps are to be formed such that masked areas and exposed areas are provided. As an illustrative example, where gaps are to be formed in the reflector, the patterned resist element is layered over the reflector to provide exposed areas and masked areas. An etching solution is applied to the exposed areas and masked areas, where the etching solution reacts with the exposed areas by removing parts of the reflector in the exposed areas. The etching solution either does not react with the resist or reacts slower than it does with the exposed reflector material. It is contemplated that other layers above the dielectric may also be similarly etched to produce gaps. For example, where the security device comprises a detection effect element layered with the reflector, the etching solution reacts with both the reflector and detection effect element in the exposed areas to create gaps in both the reflector and detection effect element. The detection effect element may be selected to provide at least one of a magnetic signal, an electrical signal, or a radiation signal.

Suitable materials for use as the patterned resist element will be apparent to a PHOSITA. Similarly, suitable washing solutions, etchants or etching solutions will be apparent to a PHOSITA.

The gaps are formed as indicia which may be negative or positive text, images, symbols, numbers, or the like or any combination thereof. Accordingly, the pattern in the patterned resist layer also forms corresponding negative or positive indicia. Preferably the gaps extend through the entire thickness of the layer into which they are formed,

Once the gaps are present and form parts of the security device, to remove or mitigate the sunglassing detriment, the dielectric and/or absorber are fracked using a fracking solution that is capable of forming perforations or lacerations into the dielectric.

Beneath the gap is at least a bi-layer of a dielectric and an absorber. This bi-layer or the dielectric, individually, reduces the contrast by producing the sunglassing detriment. Applicant has surprisingly found that by selectively choosing the appropriate strong base concentration, application speed, temperature, etc., a frack effect element is formed. This frack effect element increases the transparency of the security device.

By way of the present invention the Applicant has increased the number of effects in the security device to include color-shifting effect, indicia effect, optional detection effect and fracking effect. The fracking effect is as described below. The fracking effect is provided by the fracking effect element which is disposed beneath the gaps in the overlying layers and together with the gaps form the indicia effect element.

The frack effect element is a layer containing residue material from at least one of the absorber and the dielectric. The frack effect element is an unconsolidated layer, meaning that residues of dielectric, absorber or bilayer forming the frack effect element are separated. The residues are distributed beneath the gap in a layer that is not consolidated into a continuous layer. In one embodiment, the frack effect element is a regolith layer. As used herein, the term “regolith layer” refers to a layer of residue where each residue contains material from at least one of the dielectric and the absorber. The residues are disposed beneath the gap and are anchored to at least one of (i) the borders of the gap in the dielectric and/or the absorber and (ii) the central region of the gaps (i.e., away from the borders) of any layer remaining beneath the gaps. For example, in one embodiment, the residue is anchored to at least one of a still present layer of dielectric or absorber, or to a substrate layer present beneath the gaps.

The frack effect element produces a frack effect in the security device whereby the opacity of the dielectric or the combined opacity of the dielectric and absorber bi-layer are reduced. In one embodiment, the frack effect is the presence of the regolith layer. Surprisingly, it has been found that the presence or absence of the regolith layer also functions as a forensic feature such that its presence identifies the security device as an authentic security device and by extension functions to authenticate any product to which the security device is affixed. The presence of the regolith layer can be confirmed by at least one of visual inspection or visual inspection aided by magnifying tools or analyses. Magnifying tools include, for example, microscopes and similar tools known to those of ordinary skill in the art. Preferably, the presence or absence of the regolith layer is confirmed by a cross-sectional examination aided by the use of a scanning electron microscope (SEM).

The residues forming the frack effect element may have various sizes and shapes and naturally may also appear with the various transparencies, colors or color combinations of the components forming the residues; such as the absorber or dielectric. In a preferred embodiment the residues forming the regolith layer are below the resolution observable by the unaided human eye. In one embodiment, the frack effect element comprises residues having at least one sharp edge, as distinguished from circular residues having all round edges. Particularly, it has been surprisingly found that where the residues have a triangular shape, the resolution of the indicia formed from the gaps is significantly improved without making the regolith layer visible by the human eye. As such the forensic feature is improved since the presence or absence of the regolith layer requires more than just the human eye and will therefore require the assistance of expensive machines and tools such as SEM analysis. In such instances, security devices and/or products to which they are attached can be identified by the simple presence or absence of the regolith layer, for example. The layer of residue is dispersed such that the opacity of the dielectric and/or the absorber is reduced relative to the opacity that is present in a fully consolidated dielectric or absorber layer. Reduced opacity correlates to increased transparency such that the transparency of the dielectric and/or absorber layer is increased by at least 28%. In another embodiment the opacity is decreased by at least 28%, preferably by about 30% to about 99%; more preferably by about 30% to about 70%.

The frack effect element is formed by fracking the dielectric and/or absorber layer. While numerous methods are contemplated as suitable for fracking to produce the frack effect element, in one particular embodiment, the frack effect element is created by fracking the dielectric and/or absorber by exposing the dielectric layer to a strong base such that the dielectric develops cracks or perforations through which the strong base may enter or can contact the absorber. The strong base interacts with the absorber to etch away portions of the absorber by dissolving or dispersing portions thereof.

In one embodiment, the strong base is applied, for a period ranging from 2 seconds to about 2 minutes, to the dielectric with hydraulic force ranging from 80 to 260 Newtons such that the strong base applies an abrasive force to the dielectric. The operating temperature for the strong base may be adjusted as necessary to impact processing speed. However, it is preferred that the temperature is greater than 25° C., Preferably, the period is between about 10 seconds and 30 seconds; more preferably 12 to 17 seconds. The abrasive force increases the rate at which cracks or perforations are formed into the dielectric. This abrasive force also impacts the rate at which the strong base interacts with the underlying absorber layer to dissolve at least portions of the absorber. Without wishing to be bound by any specific theory, it is believed that the abrasive force of the strong base not only causes perforations and/or cracks in the dielectric but also that the abrasive or hydraulic force of the strong base also cracks the absorber layer to form residue or particulates that are easier to break apart. The hydraulic force being applied to the absorber, also applies a hydraulic force to the underside of the dielectric thereby increasing the rate at which the cracks in the dielectric are formed from the underside. In combination, the abrasive force on at least the first side and the hydraulic force on at least the second side (proximate the absorber) of the dielectric expedites the fracking to produce the residues of the frack effect element,

In one embodiment, the strong base is applied, as described herein, to the dielectric to create the perforations, or cracks in the dielectric and to interact with the absorber through the perforations or cracks. Alternatively, the concentration of the strong base may be adjusted in situ (e.g., through reflow or continuous flow processing) such that the strong base is highly concentrated when being applied to the dielectric but the concentration is lowered once perforations are formed and the strong base is interacting with the absorber. Alternatively, in one embodiment, the strong base is applied under hydraulic pressure until perforations are formed then is discontinued and replaced with a strong acid being applied with hydraulic force. To limit the expense of using a strong base to apply hydraulic force, a less expensive hydraulic material may be used to supplement the strong base or to simply apply the hydraulic force. Suitable hydraulic materials that are inexpensive and suitable for applying a hydraulic force will be apparent to a PHOSITA.

In one embodiment, a neutralizing material is used to reduce the expense of applying the hydraulic force and/or is also be used to neutralize the presence of any remaining base. Applicant has found, through experimentation that a suitable neutralizing material is a strong acid. Applicant has found that the use of a strong base can result in residual etching of the absorber in the lateral direction. The use of a neutralizing material prevents the residual etching, which would otherwise increase the size of the gaps and thereby reduce the resolution of the indicia effect element.

While various strong bases will be apparent to a PHOSITA, Applicant has found sodium hydroxide (NaOH) to be most suitable. In one embodiment, the NaOH is provided in a concentration ranging from about 10 wt % to about 40 wt % and having a pH ranging from about 8 to about 14; more preferably ranging from 12.0 to about 13.4. It should be understood that the temperature may be adjusted as necessary to modulate the processing time necessary for applying the NaOH. For example, it is preferred that the temperature is adjusted to greater than 25° C.; more preferably from about 30° C. to about 75° C.; or from 50° C. to about 70° C. Potassium hydroxide (KOH), lithium hydroxide (LiOH), barium hydroxide (BaOH), calcium hydroxide (CaOH), and rubidium hydroxide (ROH) are all nonexclusive examples of other suitable strong bases that can be individually applied or as a group. In a more preferred embodiment, the NaOH is provided in a concentration ranging from about 15 wt % to about 25 wt %, or in a concentration of about 20 wt %. Applicant has found that above 40 wt %, the etching reaction between the strong base and the absorber begins to decrease. Below 10 wt %, there are not enough perforations or cracks created in the dielectric to allow diffusion into the absorber layer.

While various strong acids will be apparent to a PHOSITA, Applicant has found hydrochloric acid (HCl) to be most suitable. In one embodiment, the HCl is provided in a pH within the range of less than 3. Preferably, the HCl is provided in a pH ranging from about 1.2 to about 1.6, or in a pH of 1.4. Applicant has found that a pH ranging from 1.2 to 1.6 is most suitable because it generates an appropriate amount of heat to drive the neutralization reaction to completion.

Preferably at least one of the strong base and the neutralizing material is applied with high velocity such as to provide the abrasive force or the hydraulic force needed to form the frack effect element and reduce the opacity of the dielectric or the bi-layer of dielectric and absorber. High velocity, as used herein-throughout in reference to the hydraulic force of the strong base or acid, can be adjusted as necessary to obtain an applied force suitable for creating perforations or the fracking effect element. It is particularly preferred that the velocity is adjusted to provide an applied force of greater than 60 Newtons; more preferably ranging from 80 to 260 Newtons; or even more preferably ranging from about 100 to about 180 Newtons.

In one particular embodiment, the fracking is accomplished by applying NaOH, concentrated in the range of from 15 wt % to 25 wt %, to the exposed areas with high velocity. Preferably, the NaOH pH ranges from about 10 to about 12.8 at a temperature ranging from about 30° C. to about 75° C. The NaOH creates cracks and/or perforations in the dielectric such that the NaOH can pass therethrough and react with the absorber to dissolve portions thereof and applying hydraulic force ranging from about 60 to about 180 Newtons to the absorber and dielectric to break apart the bi-layered laminate of the dielectric and absorber into residues that form a regolith layer.

In another particular embodiment, the fracking is accomplished by applying NaOH, concentrated in the range of from 15 wt % to 25 wt %, to the exposed areas with high velocity to apply a hydraulic force of about 60 to about 180 Newtons, Preferably, the NaOH pH ranges from about 10 to about 12.8 at a temperature ranging from about 30° C. to about 75° C. The NaOH creates cracks and/or perforations in the dielectric such that the NaOH can pass there through and react with the absorber to dissolve portions thereof and applying hydraulic force to the absorber and dielectric to break apart the bi-layered laminate of the dielectric and absorber into residues that form a regolith layer. An effective amount of HCl, with a pH ranging from 1.2 to 1.6, is applied at high velocity to apply a hydraulic force of about 60 to about 180 Newtons to the exposed areas to break apart the bi-layered laminate and to neutralize the NaOH.

Fracking of the dielectric and absorber produces the regolith layer which has a transparency that is at least 28% greater than the transparency of the surrounding dielectric or combined transparency of the dielectric and absorber. The regolith layer along with the gaps, in the form of indicia, increases the contrast between the indicia and the surrounding materials forming the layers of the security device. As such, the indicia effect is observable in both reflected and transmitted light. Moreover, the regolith layer provides a forensic feature which can be used to further authenticate the security device and any product to which it is attached. The regolith layer includes residues of the dielectric, residues of dielectric layered with absorber, or residues of absorber each of which are anchored to the layered material at the boundary of the gaps/and to a layer beneath the absorber such as a device substrate. Such residues are also found in the center of the gaps and are anchored to a layer beneath the absorber such as the device substrate. This regolith layer can be identified with known analytic tools and methods.

In one embodiment of the product, the product comprises a product substrate and a security device providing a color-shifting effect, an indicia effect and a frack effect as described herein. As will be apparent from the present disclosure several other embodiments of the security device, the method of making the security device, a product containing the security device and methods of preparing the product are within the scope of this invention.

There are several security device embodiments contemplated within the scope of this invention that include other components in addition to the color-shifting effect element, the indicia effect element and the fracking effect element. The color-shifting effect element can optionally be layered with at least one of a device substrate layer and a detection effect element. Some or all of the absorber, dielectric, reflector and detection effect element layers can be stacked over or beneath the substrate layer. In a preferred embodiment, the layers are stacked over the substrate layer. While various methods of stacking the layers of the security device will be apparent to a PHOSITA, it is particularly preferred that at least one of the layers is applied by vapor deposition in a layered manner, whether over or beneath the substrate: preferably over—in succession, one after the other, such that the absorber is applied, followed by the dielectric, followed by the reflector and optionally followed by a separate layer of detection effect element. Suitable vapor deposition techniques include, for example, chemical vapor deposition (CVD), physical vapor deposition (PVD), electron beam vapor deposition, electric arc vapor deposition, resistance heating vapor deposition, induction heating vapor deposition, or plasma activated vapor deposition. Alternatively the layers can also be successively layered by printing.

In one embodiment of the method of producing a security device, a color-shifting effect element is provided over a device substrate and gaps are formed in the reflector as described above. A detection effect element is then layered over the reflector to provide a detection effect. In one embodiment, gaps are provided in the detection effect element, which are complementary to the gaps in the reflector such that the gaps overlap. Overlapping gaps may be either identical or be relatively smaller or larger. In a preferred embodiment, gaps in the detection effect element are larger than gaps in the reflector. A fracking effect element is then created in the security device.

In one embodiment of the method of producing a security device, a color-shifting effect element is provided over a device substrate and a detection effect element is layered over the color-shifting effect element. Gaps are then created in the detection effect element and the reflector at the same time. A fracking effect element is then created in the security device.

Suitable device substrate materials include polyethylene terephthalate, polycarbonate, polyvinyl chloride, polyacrylates, polyacrylonitrile, polystyrene, polypropylene, polynaphthalene terephthalate, and mixtures or copolymers thereof.

In one embodiment, the color-shifting effect element is provided as described above, layered over a device substrate layer and layered under a detection effect element. A patterned resist layer, providing positive or negative indicia, is applied over the reflector, the detection effect element, over both or between the two. Where it is over both the detection effect element and the reflector or just over the reflector, it is applied such that there are areas where the resist is present and areas where the resist is absent. Areas where the resist are present are considered masked areas, whereas areas without resist are considered exposed areas. The exposed areas are etched away by an etchant to provide gaps in the form of indicia in the reflector, the detection effect element or both. The etchant may be applied under various conditions suitable for removing at least part (i.e., full or partial depth) of the reflector in exposed areas. While various etchants are contemplated, such as mechanical and chemical etchants, it is preferred that the etchant is a chemical etchant such as NaOH though other etching solutions will be apparent to a PHOSITA.

In one embodiment, the patterned resist is applied over the detection effect element which is layered over the reflector, which is layered over the dielectric which is in turn layered over the absorber, which is layered over a substrate layer. The exposed areas are of detection effect element over reflector, dielectric, absorber and substrate. The etchant is applied to the exposed areas to remove the detection effect element in the exposed areas and remove the reflector in the exposed areas to produce gaps in the form of indicia. The fracking effect element is then provided as described herein.

In another embodiment, the patterned resist is applied over the reflector as described above such that exposed areas expose reflector layered over dielectric which is layered over absorber which is layered over an optional substrate. An etchant is applied to the exposed areas to remove exposed areas of the reflector to form gaps in the form of indicia. A detection effect element is then applied over the reflector and/or the resist. The fracking effect element is then provided as described herein.

In each of the embodiments described herein where a patterned resist is applied, it is contemplated that the patterned resist may be removed or may be left in place after the gaps are formed.

In one embodiment, the security device includes a color-shifting effect as described herein, an indicia effect as described herein, and a detection effect as described herein. The detection effect element as used herein refers to an element in the security device that provides a signal that is detectable such as a magnetic signal, electric signal or both. In a preferred embodiment the detection effect is a magnetic signal that is provided by the detection effect element separate from the reflector. However, it is also contemplated that a detection effect is also provided by the reflector. Applicant has found that most materials that are suitable for the reflector have less distinct magnetic properties. Accordingly, it is preferred that the detection effect provided by a detection effect element as described herein that is separate from the reflector. Where the reflector also provides a detection effect in the form of a magnetic signal, a suitable material for the reflector is a cobalt nickel alloy. The magnetic signal can be defined by at least one of remanence and coercivity. These properties will be affected by the thickness of the detection effect element. It will be apparent to a PHOSITA what thickness is appropriate to determine a desired magnetic signal. For purposes of maintaining the security device with an appropriate thickness it is preferred that the detection effect element has a thickness of less than 1200 nm; preferably between 5 nm and 1200 nm and more preferably between 100 nm and 200 nm.

Along with being in a layer, the magnetic material may also be present in the device as a coding such as a bar code.

In one aspect of the invention, a product is provided. In one embodiment, the product comprises a security device that is affixed thereto. As used herein, the term “affixed” refers to the attachment of the security device to the product by being embedded beneath the substrate, being applied over the substrate or being partially embedded to provide windows of exposed security device and areas where the device is covered by the product substrate. For example, in one specific embodiment, the product comprises a product substrate and a security device affixed to the product substrate by being, for example, applied to an exposed surface, buried beneath the exposed surface of the substrate, or is affixed in a windowed format to the product substrate,

A PHOSITA will understand that a suitable absorber functions to partially reflect and to partially transmit light. The reflected portion of the light from the absorber will interfere with light reflected from the reflector and it is this interference which provides color to the device. The specific color provided can be modulated by the thicknesses of the absorber, reflector and the dielectric layer between the layer having the absorber and the layer having the reflector. The dielectric controls the wavelength at which the light reflected from the reflector interferes with the light reflected from the absorber. In instances where the interference is destructive, a large portion of the light will be absorbed in the device. However, where the interference is constructive, most of the light not transmitted through the device will be reflected. Accordingly, it can be seen that it is the combination of high reflectance at some wavelengths and low reflectance at others that gives the device its characteristic hue. For example, a green-to-blue color-shifting effect can be provided such that light coming into the device at a relatively small angle would produce a green color. However, as the angle of incident increases the device would produce a blue color.

In one embodiment the absorber and the reflector are made of the same material. Here, if these layers are made of the same thickness, then the same color-shifting effect will generally be observed whether the device is viewed from the reflector side or the absorber side of the dielectric.

While various materials suitable as absorbers will be apparent to a PHOSITA, it is preferred that the absorber be selected from at least one of chromium, iron, gold, titanium, nickel chromium iron compounds, vanadium, palladium, molybdenum, nickel, cobalt, tungsten, niobium, aluminum, metallic fluorides, oxides, sulphides, nitrides, carbides, phosphides, selenides, silicides, carbon, germanium, cermet, iron oxide. Preferably, the transmittance of the absorber ranges from 20% to 55%, In a preferred embodiment the thickness of the absorber layer ranges about from 3.5 nm to about 25 nm; more preferably from 4.5 nm to 10 nm.

It is also contemplated in one specific embodiment that the dielectric and the absorber are the same material. Under such circumstances, where adjoining dielectric layers are provided, it is preferable that the refractive indices of the two dielectric layers are substantially different thereby providing a distinct and observable colorshift. An n value of greater than 1.5 for one dielectric and an n value of less than 1.5 for the other would be suitable.

Suitable dielectrics comprise at least one of Al₂O₃, ZrO₂, TiO₂, SiO₂, ZnS, MgF₂, indium tin oxides and SiOx wherein 1≤x≤2, Aluminum fluoride, cerium fluoride, lanthanum fluoride, sodium aluminum fluorides, neodymium fluoride, samarium fluoride, barium fluoride, calcium fluoride, and lithium fluoride; zinc sulfide, zinc oxide, zirconium oxide, titanium dioxide, indium oxide, indium-tin-oxide, tantalum pentoxide, ceric oxide, yttrium oxide, europium oxide, iron oxides, hafnium nitride, hafnium carbide, hafnium oxide, magnesium oxide, neodymium oxide, praseodymium oxide, samarium oxide, antimony trioxide, silicon carbine, silicon nitride, silicon monoxide, selenium trioxide, tin oxide, and, tungsten trioxide; acrylates, perfluoroalkanes, polytetrafluoroethylene, and fluorinated ethylene propylene. In one embodiment, the dielectric is provided with a thickness ranging from about 100 to about 100 nm; preferably ranging from 200 to 500 nm.

A PHOSITA understands that various materials may be used alone or in combination to form the reflector layer. Preferably, the reflector is in the form of a metal layer that is strongly reflecting. Suitable reflectors include at least one of tin, nickel, palladium, aluminum copper, chromium, cobalt, niobium, platinum silver, gold and alloys thereof.

While it is contemplated that the detection effect element may provide magnetic, electrical, or other detectable properties known to a PHOSITA, it is herein preferred that the detection effect element comprises magnetic materials that display detectable magnetic properties. In a preferred embodiment, the magnetic material is in a layer distinct from the reflector. Under such circumstances the reflective properties of the reflector and the magnetic properties of the detection effect element can each be independently maximized without compromising the properties of the other. Suitable magnetic materials for use as the detection effect element include a magnetic metal layer comprising nickel, iron, cobalt or an alloy consisting of these metals or an alloy consisting of at least one these metals; preferably comprising 20% of the alloy. It is however, also contemplated within the scope of the present invention that the detection effect can be provided by providing the detection effect element in the same layer as the reflector. For example, in one embodiment, the reflector is provided with both reflective and magnetic properties such that the detection effect is present in the reflector solely, or is provided in both the reflector and the detection effect element where the detection effects are the same or different.

The security device may be provided with or without a device substrate. Suitable device substrates include plastic films known to a PHOSITA. In one embodiment, the device substrate comprises polyethylene terephthalate (PET). The security device may be provided with or without a device substrate layer, though it is preferred that the device substrate layer is present. Likewise it is contemplated within the scope of this invention that the product comprises a security device with or without a device substrate.

In one embodiment, the security device combines four security effects (color-shifting effect, indicia effect, fracking effect and detection effect) into a single device thereby improving the complexity of the device and thereby reducing the likelihood of duplication. It will be appreciated by a PHOSITA that other effects may also be incorporated into the security device. One such exemplary additional feature is a diffraction effect which is provided by incorporating a diffraction structure into the security device. The diffraction element can be provided by embossing and can include at least one of a diffraction grating, refraction patterns, reflection, transmission, or volume holograms. The embossed diffraction element can be embossed into the device substrate or into a separate layer that is applied on the device substrate. Preferably, the diffraction is present in front of a reflective background such as the reflector. The diffraction element allows the security device to produce further color-shifting effects. These color-shifting effects depend on the amount of diffraction produced by the diffraction element which has a relief structure that can diffract incident light. Optimal hologram effects are observed when the diffraction element adjoins the reflector. Where the diffraction element is in a separate layer, it may be provided by disposing a layer of lacquer over the device substrate into which the relief structure of the diffraction element can be embossed. Suitable diffraction elements can be selected from the group consisting of diffraction grating, holograms, corner cube reflectors and refraction patterns.

### EXAMPLES

The following embodiments are herein presented as non-limiting examples of the security device and the method of preparing the security device.

FIG. 1 provides an embodiment of the color-shifting effect (CSE) element wherein a dielectric (D) is disposed between a reflector (R) and an absorber (A). These components of the CSE element are layered such that viewing from the side of the reflector will produce a color shifting effect when the CSE element or the security device it is incorporated into is viewed from varying points of view. It is contemplated that further components may also be layered with the CSE element. For example, a diffraction structure, a device substrate(s) or a detection effect element (m), or any combination thereof may also be layered with the CSE element.

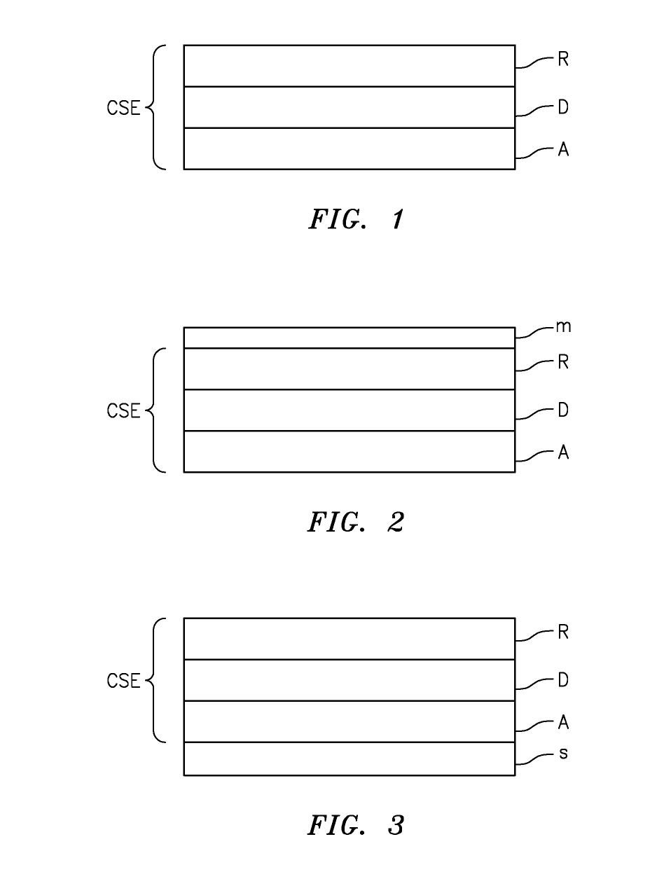

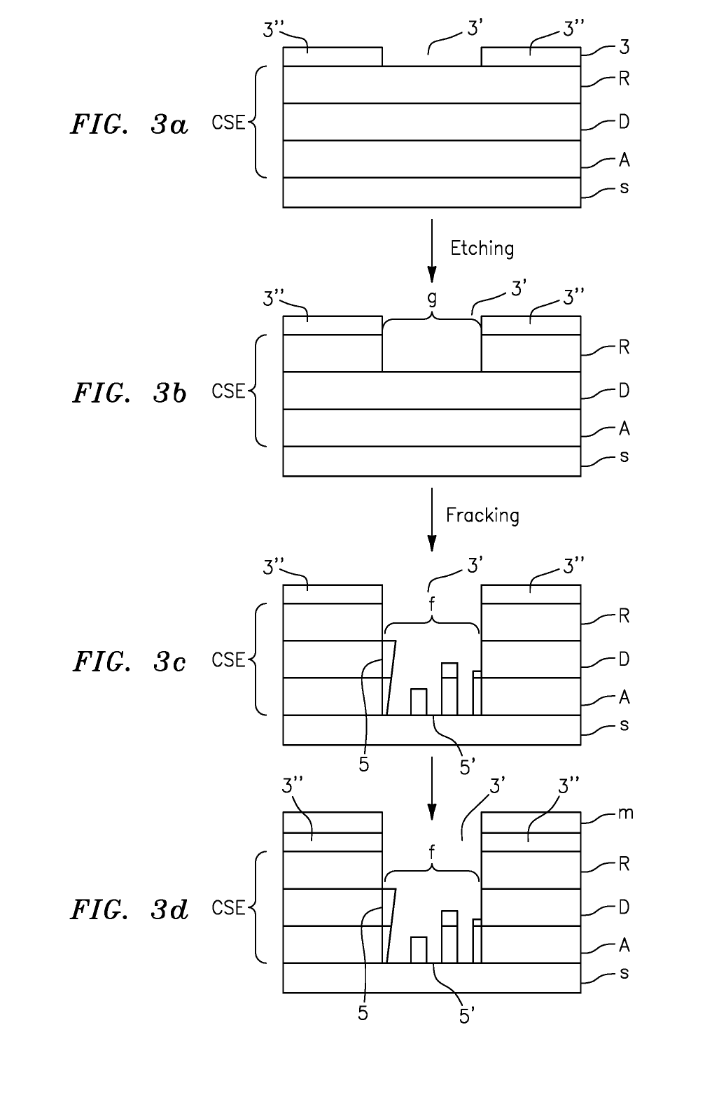

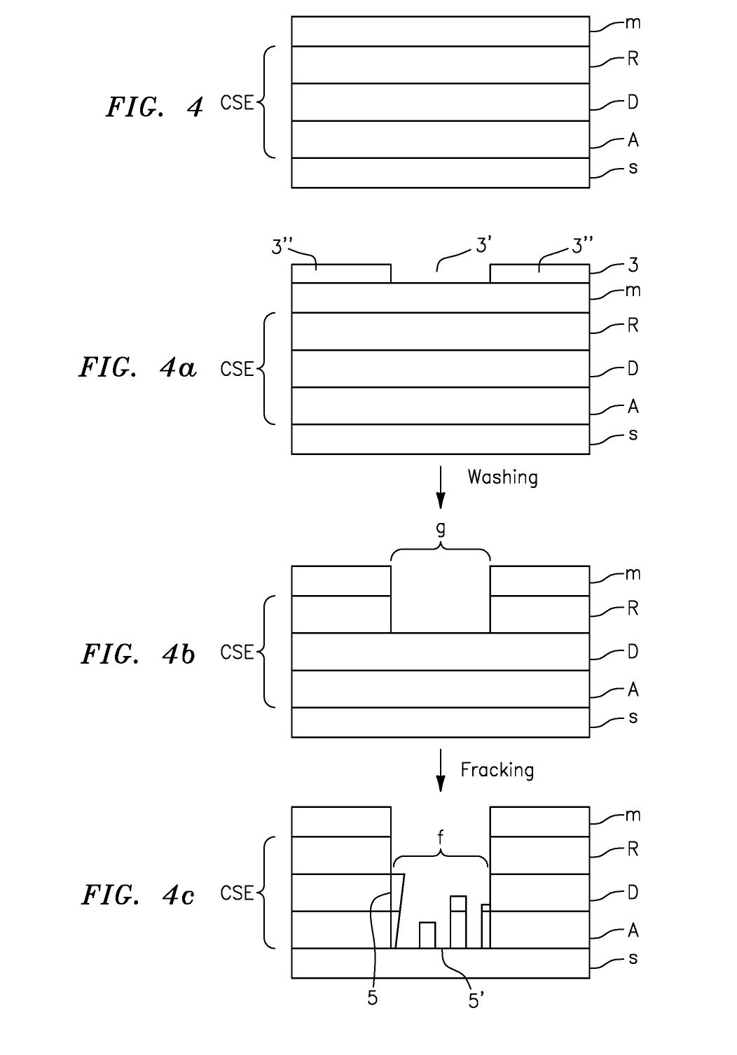

FIG. 2 provides an embodiment of the CSE element layered with a detection effect element (m) such that the detection effect element is layered over and on the reflector (R). Alternatively, FIG. 3 shows an embodiment where a device substrate layer(s) is layered with the CSE element such that the CSE element is layered over the substrate(s). In a further embodiment, provided in FIG. 4, the CSE element is layered between a detection effect element (m) and a device substrate(s).

FIGS. 3a-3d provide an embodiment of the method of forming the security device (3d). Here a CSE element is provided in accordance with FIG. 3. A layer of patterned resist (3) is printed onto the reflector (R) to provide masked areas (3″) and exposed areas (3′). The CSE element with patterned resist (FIG. 3a) is then exposed to an etchant or etching solution of NaOH (20 wt %). The etchant reacts with the reflector (R) in the exposed areas (3′) to remove parts of the reflector (R), producing a CSE element with gaps (g) in the reflector (R) as depicted in FIG. 3b. Beneath the reflector (R) is a bi-layer of dielectric (D) and absorber (A). The gaps (g) are in the form of indicia that are contrasted against the adjoining reflector (R). However, the contrast is not optimal because of the bi-layer of dielectric (D) and absorber (A). The bi-layer produces a sunglassing detriment which obscures the contrast between the indicia and the surrounding adjoining reflector (R). As a result the resolution of the indicia is hindered. Without wishing to be bound by any specific theory, it is believed that the opacity of the bi-layer is responsible for the sunglassing detriment. Accordingly, the opacity of the bi-layer is reduced by fracking the bi-layer. To frack the bi-layer a highly concentrated fracking solution of a strong base (e.g., NaOH) is applied to the dielectric (D) with hydraulic force such that lacerations, cracks and holes are formed in the dielectric (D). For the purpose of cost efficiency, the concentration of the etchant is lower than the concentration of the strong base in the fracking solution. These lacerations, cracks and holes allow the strong base to diffuse there through and to interact with the absorber (A) below. The turbulence of the interaction with the absorber (A) and the heat produced therefrom, further impacts the dielectric (D). The reaction of the strong base with the absorber and the dielectric (D) causes the bi-layer to be fracked thereby removing chunks of the bi-layer and leaving behind a regolith layer of bi-layer (f) residue as depicted in FIG. 3c. The residues are anchored to the border (5) or the center region (5′). The CSE element is therefore presented with a color-shifting effect, an indicia effect produced from gaps (g) and fracking element (f) and a frack effect produced by the fracking element (f). This CSE element is then layered with a detection effect element (m) provided by CVD of a magnetic layer as shown in FIG. 3d. The security device provided in FIG. 3d provides a color-shifting effect, an indicia effect with improved resolution in reflected and transmitted light, a detection effect, and a fracking effect.

FIGS. 4a-4c provides an alternative embodiment of the method whereby the CSE element is layered with a detection effect element (m) through CVD of a metallic layer over the reflector (R). The detection effect element (m) and CSE element are layered over a device substrate(s) layer as provided in FIG. 4a. A layer of patterned resist 3 above the detection effect element (m) provides masked areas and exposed areas. The resist material is washable such that exposing the resist to washing solution removes the resist in the masked areas and also removes reflector (R) material and magnetic detection effect element (m) material from the masked areas to produce a CSE element with gaps (g) (FIG. 4b). The CSE element is then fracked as described above to reduce the opacity of the bi-layer of dielectric (D) and absorber (A). While the concentration of the strong base can be adjusted during the fracking process, in the present embodiment the concentration of the fracking solution is held steady at about 20 wt %. The resulting security device comprises a device substrate layer that is layered with a CSE element that includes a dielectric (D) layer disposed between a reflector (R) and an absorber (A). The security device also comprises gaps (g) in the reflector (R) and in the magnetic layer (m). Importantly, the security device also comprises a regolith layer (g) of bi-layer residues and absorber residues. The security device provided in FIG. 4c provides a color-shifting effect, an indicia effect with improved resolution in reflected and transmitted light, a detection effect, and a fracking effect.

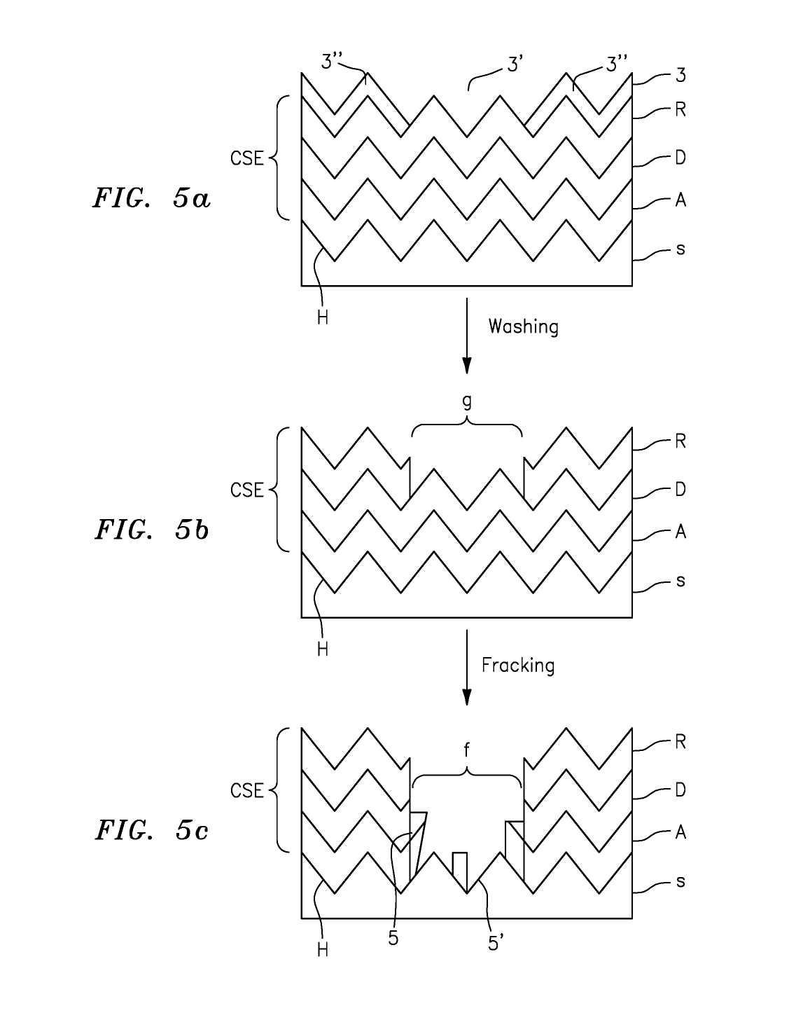

FIGS. 5a-5c provides an embodiment of the process for manufacturing a security device similar to that described in FIGS. 4a-4c, where a relief structure (H) is embossed into the security device to provide a hologram. The hologram is aided by being adjoined to the reflector (R). Gaps (g) and (rack effect elements are formed as described in FIGS. 4b-4c. As a consequence the security device (FIG. 5c) provides a color-shifting effect, an indicia effect with improved resolution in reflected and transmitted light, a detection effect, a fracking effect, and a hologram effect.

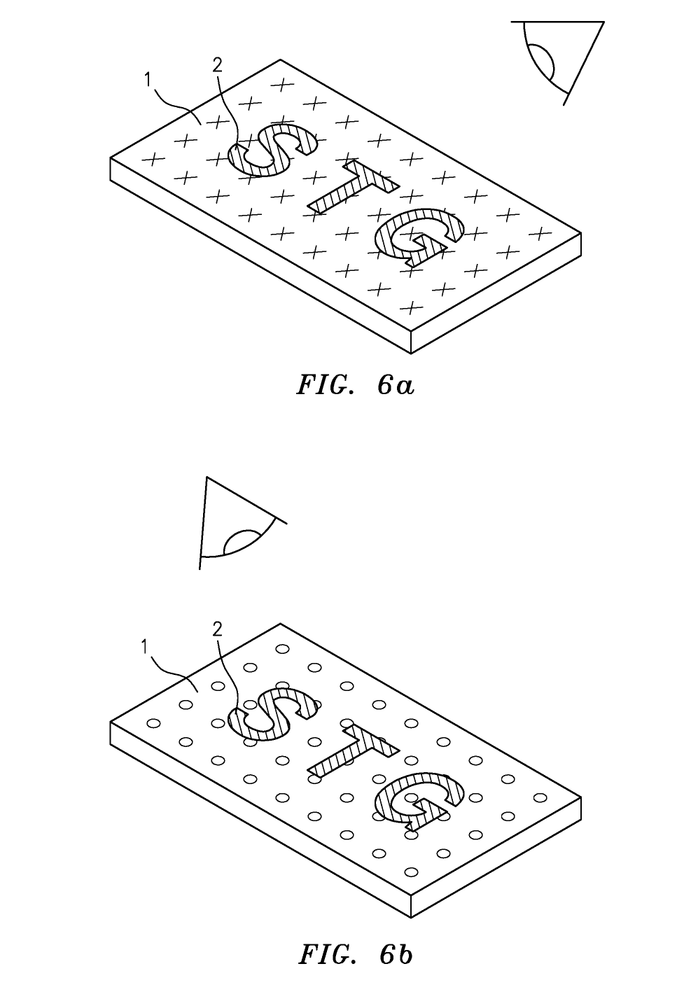

FIGS. 6a-6b provide an embodiment of the security device having gaps in the form of indicia (2) and a color-shifting effect (1) as viewed from one point of view wherein the green color (x) is depicted in FIG. 6a. As the point of view is changed the color shifts from green (x) to blue (o) as depicted in FIG. 6b. Importantly, the indicia effect is observable in reflected light.

All ranges disclosed herein are intended to be understood as including all sub-ranges therein.

While various embodiments of the present invention have been described above it should be understood that they have been presented by way of example only, and not limitation. Thus, the breadth and scope of the present invention should not be limited by any of the exemplary embodiments.

The invention claimed is:

1. A security device comprising:
a color-shifting effect element that includes an absorber, a dielectric and a reflector that are layered such that the dielectric is disposed between the absorber and the reflector; and
an indicia effect element having (i) gaps in the reflector, and (ii) a frack effect element disposed beneath the gaps in the reflector;
wherein the color-shifting effect element is layered with an optional detection effect element, such that when present the reflector is disposed between the dielectric and the detection effect element.

2. The security device of claim 1, wherein the color-shifting effect element is layered with the detection effect element.

3. The security device of claim 1, wherein the color-shifting effect element is layered over a device substrate.

4. The security device of claim 1, wherein the frack-effect element increases the transparency of at least one of the dielectric and the absorber by an amount ranging from about 40% to about 80%.

5. The security device of claim 1, wherein the frack-effect element comprises a regolith layer disposed beneath the gaps in the reflector and formed from residue containing material from at least one of the dielectric and the absorber.

6. The security device of claim 1, wherein the absorber and the dielectric are at least semi-transparent such that the gaps in the reflector and the frack-effect element provides a contrast against the remaining portions of the color-shifting-effect element and the remaining portions of the detection effect element to provide an indicia that is visually observable through at least one of reflected and transmitted light.

7. The security device of claim 1, wherein the absorber comprises at least one of chromium, iron, gold, titanium, nickel chromium iron compounds, vanadium, palladium, molybdenum, nickel, cobalt, tungsten, niobium, aluminum, metallic fluorides, oxides, sulphides, nitrides, carbides, phosphides, selenides, silicides, carbon, germanium, cermet, iron oxide.

8. The security device of claim 1, wherein the dielectric comprises at least one of Al₂O₃, ZrO₂, TiO₂, SiO₂, ZnS, MgF₂, indium tin oxides and SiOₓ wherein 1≤x≤2, aluminum fluoride, cerium fluoride, lanthanum fluoride, sodium aluminum fluorides, neodymium fluoride, samarium fluoride, barium fluoride, calcium fluoride, and lithium fluoride; zinc sulfide, zinc oxide, zirconium oxide, titanium dioxide, indium oxide, indium-tin-oxide, tantalum pentoxide, ceric oxide, yttrium oxide, europium oxide, iron oxides, hafnium nitride, hafnium carbide, hafnium oxide, magnesium oxide, neodymium oxide, praseodymium oxide, samarium oxide, antimony trioxide, silicon carbine, silicon nitride, silicon monoxide, selenium trioxide, tin oxide, and, tungsten trioxide; acrylates, perfluoroalkanes, polytetrafluoroethylene, and fluorinated ethylene propylene.

9. The security device of claim 1, wherein the reflector comprises at least one of tin, nickel, palladium, aluminum copper, chromium, cobalt, niobium, platinum silver, gold and alloys thereof.

10. The security device of claim 1, further comprising a diffraction element selected from the group consisting of diffraction grating, holograms, corner cube reflectors and refraction patterns.

11. The security device of claim 10, wherein the diffraction element is embossed in at least one of the absorber, the dielectric, the reflector, the optional detection effect element, a separate layer or any combination thereof.

12. The security device of claim 1, wherein the detection effect element includes at least one material capable of producing or inducing at least one of a magnetic signal, an electrical signal, or a radiation signal.

13. The method of claim 1, wherein the detection effect element is a layer containing magnetic material or electrically conductive material.

14. The security device of claim 1, wherein the indicia effect element comprises gaps in the reflector and gaps in the detection effect element and the frack effect elements in the dielectric and the absorber.

15. The security device of claim 14, wherein the indicia effect element is in the form of at least one of letters, numbers, symbols, and patterns.

16. The security device of claim 1, further comprising a device substrate element layered with the color-shifting effect element and the optional detection effect element when present; wherein the substrate is selected from the group consisting of polyethylene terephthalate, polycarbonate, polyvinyl chloride, polyacrylates, polyacrylonitrile, polystyrene, polypropylene, polynaphthalene terephthalate, and mixtures or copolymers thereof.

17. The security device of claim 1, further comprising a patterned resist element layered with the color-shifting effect element and the optional detection effect element when present.

18. The security device of claim 1, further comprising a detection effect element layered on the reflector that produces a magnetic signal and comprises a device substrate layered below the absorber;
wherein the indicia effect element has (i) at least one gap in the reflector and the detection effect element, and (ii) the frack effect element comprises a regolith layer of residues of the bi-layer of dielectric and absorber; and
wherein the security device provides a color-shifting effect, an indicia effect, a frack effect, and a detection effect.

19. The security device of claim 1, wherein the device alternates between at least two colors as the device is viewed from different points of view.

20. The device of claim 1, wherein the reflector comprises a magnetic material.

21. The device of claim 1, wherein the color-shifting effect element is in the form of flakes dispersed within a medium.

22. The security device of claim 21, wherein the device alternates between at least one of gold-to-green, magenta-to-gold, magenta-to-silver, green-to-magenta, green-to-silver, and blue-to-red.

23. A method of preparing a security device comprising:
providing a color-shifting effect element, optionally layered with a detection effect element, the color-shifting effect element comprising an absorber, a dielectric and a reflector that are layered such that the dielectric is disposed between the absorber and the reflector;
creating gaps in the reflector and optionally the detection effect element; and
reducing the opacity of a bi-layer of dielectric and absorber, relative to the opacity of the bi-layer in areas adjoining the gaps and a frack effect element.

24. The method of claim 23, wherein the gaps in the reflector and optionally the detection effect element are created by layering a patterned resist element with the color-shifting effect element to form masked areas and exposed areas and etching the exposed areas or washing the masked areas to provide gaps in the reflector and optionally the detection effect element; and
wherein reducing the opacity of the bi-layer of dielectric and absorber comprises exposing the bi-layer to a strong base for a period ranging from 2 seconds to 2 minutes at a base concentration ranging from 10 wt % to 40 wt %.

25. The method of claim 24, wherein the patterned resist element is washable.

26. The method of claim 23, wherein the opacity of the bi-layer is reduced by exposing the bi-layer to a fracking solution of NaOH concentrated between 10 wt % and 40 wt %;
wherein the NaOH is applied with hydraulic force such that holes and/or cracks are formed in the dielectric; and
wherein the NaOH reacts with the absorber to produce residues of the bi-layer or the absorber that are anchored to the boundaries of the frack effect element and/or on the device substrate.

27. A product comprising the security device of claim 1 affixed thereto.

28. The product of claim 27, wherein the product is a banknote.

29. The security device of claim 1, wherein the frack effect element is a forensic feature.

30. A security device produced by the method of claim 23, the security device comprising
a color-shifting effect element that includes an absorber, a dielectric and a reflector that are layered such that the dielectric is disposed between the absorber and the reflector; and
an indicia effect element having (i) gaps in the reflector, and (ii) a frack effect element disposed beneath the gaps in the reflector.
